(19) United States
(12) Patent Application Publication
(10) Pub. No.: US 2024/0232569 A9
(43) Pub. Date: Jul. 11, 2024

(54) SYSTEMS AND METHODS FOR CREATING SIMULATED VIRTUAL ENVIRONMENTS

(71) Applicant: Alfredo Munoz, Jersey City, NJ (US)

(72) Inventor: Alfredo Munoz, Jersey City, NJ (US)

(21) Appl. No.: 17/971,576

(22) Filed: Oct. 22, 2022

(51) Int. Cl. G06N 3/006; G06Q 20/06; G06Q 20/10; G06Q 20/12; G06Q 20/38; G06Q 30/0601; G06Q 50/16; G06T 13/40; G06T 19/00

(52) U.S. Cl. CPC G06N 3/006; G06Q 20/065; G06Q 20/10; G06Q 20/1235; G06Q 20/381; G06Q 30/0609; G06Q 50/16; G06T 13/40; G06T 19/00; G06Q 20/389; G06T 2219/024

(57) ABSTRACT

A method of creating a virtual environment. The virtual environment generated by a computer program that is executed in a computer network system, the method comprising the steps of generating one or more virtual avatars representing one or more real-world users, generating a virtual environment wherein each virtual avatar belongs to one of a plurality of user profiles, and defining a periodic requirement enabling each virtual avatar to exist within the virtual environment; defining assets inside the virtual environment. The method includes establishing at least one earning method for each virtual avatar to earn the defined assets, allowing to earn the defined assets within the virtual environment based in part on the at least one earning method and defining a periodic asset allocation of the defined assets that is equivalent to the periodic requirement by each virtual avatar. Each virtual avatar within the virtual environment is required to make the periodic asset allocations to exist inside the virtual environment.

### FIELD

The present disclosure relates generally to simulated environments. More particularly, the present disclosure relates generally to creating computer-based simulated virtual environments. For example, these may be interactive, navigable, virtual environments like a virtual representation of a future physical environment. The present disclosure describes methods, processes and systems that allow for a real-world user to control and/or enable activities of a virtual avatar within such a virtual representation of a future physical environment.

The present disclosure also generally relates to defining assets for use within the virtual environment, such as Fungible Tokens and/or Non-Fungible-Tokens (NFTs). The Fungible Tokens may be limited in numbers and may also act as the platform financing token, and the internal transactional economic tools that can be created and burnt by the users while interacting in the virtual environment. Non-Fungible-Tokens (NFTs) may comprise Solid or Temporary Tokens. The Solid NFTs are those where the user is the owner of the digital asset and the owner can enjoy, rent or sell such asset as desired. A Temporary NFT comprises limitations to its use. For example, they may disappear over time, it may become a Solid NFT or it comprise a Conditional NFT. That is, a Token linked to a certain activity to be performed by the owner of the NFT.

### BACKGROUND

A computer-based system can create immersive virtual environments wherein real-world users or participants inhabit and interact with other real world user's avatars and other related virtual items and structures. The present disclosure generally relates to technologies that facilitate simulating a future scenario by creating one or more immersive or virtual environments wherein the immersive or virtual environment is based on an innovative ecosystem.

In one arrangement, these innovative ecosystems incorporate certain systems, methods, and/or tools associated with the creation and maintenance of a metaverse. However, these innovative ecosystems may be virtually structured in different ways, such as structured as a digital twin. Such a digital twin may sometimes be referred to in the art as a real-time replica, of potential future physical environments.

In the presently disclosed futuristic digital twin immersive environment or environments, active participants interact with each other by way of various means and methods as described in detail herein. In one preferred arrangement, these active participants have a bidirectional relationship with the digital twin. That is, these active participants provide feedback and also give rise to various sources of its improvements within the future of the real world over time. With the disclosed innovative ecosystems and methods and systems for creating these communities, the active participants become community members. These community members then become the creators of the future. These immersive virtual ecosystems instill cross-pollination of ideas to test and learn from a possible future so that these ideas can then be implemented in the present real world.

The present disclosure is also generally directed to using technologies in the metaverse to leverage an opportunity to create a simulation of future scenarios. In such future scenarios, a number of technologies are implemented to create an immersive collection of one or more communities. As an example, technologies utilized include virtual reality. Blockchain technologies may also be utilized so as to allow the situation of governance or a virtual economy. Furthermore, digital assets will be relied upon to simulate future scenarios and then incorporate their relationships of those communities within those futuristic scenarios.

By way of these interactions and futuristic scenarios, information and data can then be obtained relating to the results of a large amount of people existing in a immersive virtual environment. In addition, how these individuals will interact in a digital twin of future real-world environment will also be utilized to predict similar future interactions in the real world. And how these individuals will respond to this immersive environment and how, in the real world, these individuals can respond to this immersive environment in the future.

From a scientific standpoint, this will allow for an understanding of how people and communities will interrelate with one another in a future environment. In addition, the presently disclosed digital platforms are structured so as to simulate the politics and economy, so the core of the metaverse can be used so as to simulate the reality but in the future. The presently disclosed digital platforms can be used for building that simulated and futuristic environment to learn from it and how citizens will interact with one another in the future, like for example under harsh or difficult environments, or as another example in future neighborhoods or real estate developments inside a physical city.

In addition, such a platform can be used to gather, collect and identify societal feedback and interactions to this digital twin. Information that can be used for changing or revising future real-life environment based on the feedback of the community existing within these virtual, and potentially harsh environments. The community can contribute to creating a digital environment by communicating and interacting with one another. A digital environment can improve over time based on this feedback from the community by bridging the user and the experience of the future through the virtual environment.

The disclosed virtual environments will provide teachings as to how to envision the future and how the community will enjoy the future and interact with one another, travel to remote locations and will eventually be forced to exist in these environments. The present disclosure may also be used to investigate or study sustainability issues. That is, how can communities sustain themselves in harsh environments.

At least two primary goals can be identified, and these are sustainability or climate change and social change. The present disclosure allows for the identification of ideas to help solve some of these problems by using these technologies in such a digital twin virtual platform. The information obtained from simulating future scenarios may lead to insights on how to solve problems in the present, especially those that may be considered even more extreme in a potential future.

It is sometimes difficult to innovate if the same questions are asked all the time. With the disclosed environments, we can ask a different questions under a different environmental constraint that has different inherent characteristics from the existing real world. With such a simulated environment, we can witness what happens if we have to re-invent society from ground zero within a different or harsh environment. We will also be able to understand how the relationship amongst different class groups is, relationships between the people and the natural resources, relationships with the supply chains, relationships as to how the communities can grow and expand as a civilization,

Additionally, one of the limitations of certain known virtual environments is that they offer the purchase or provide for certain ownership rights of virtual property. However, in such virtual environments, there is no requirement for the landowner to provide any type of required use of the land or virtual property under a certain amount of time. Therefore, in many situations, such ownership is entirely predicated upon the concept of asset speculation. That is, virtual land may be purchased with the single goal of maintaining ownership and speculating that the value of the virtual property will increase over time. There is no utilitarian use of the land for any specific purpose for either the landowner or the overall community of the virtual environment. With many such known virtual environments, there is no need that landownership requires the landowner to utilize the virtual land to perform some beneficial function or beneficial activity on behalf of the virtual community or other citizens of the virtual environment. Such inactivity may be deemed inefficient and is not beneficial as such inactive or nonperformance ownership does not allow the community grow and prosper in the virtual environment.

The presently disclosed systems and methods utilize technology, and tools such as virtual reality, decentralized systems, or blockchain, to create an ecosystem that leads to innovative solutions that help to make life better for virtual communities and future generations. In one arrangement, the disclosed systems and methods provide a mechanism by which virtual land ownership is conditional on the requirement that land ownership must be functionally utilized for the betterment of the community and to make existence or survival within the virtual environment (such as a virtual harsh environment) less burdensome for those thriving within the virtual community.

The presently disclosed systems and methods disclose a virtual ecosystem with an internal economy that may be directly related to the level of complexity for human survival in a harsh (extreme) environment of a potential future scenario, such as those where people will need to create societies in off-world settlements, postapocalyptic situations due to a potential global war, or even due to the rapid climate change that is currently happening.

### SUMMARY

According to an exemplary arrangement, a method of creating a virtual environment, the virtual environment generated by a computer program that is executed in a computer network system, the method comprising the steps of generating one or more virtual avatars representing one or more real-world users; generating a virtual environment wherein each virtual avatar belongs to one of a plurality of user profiles; defining a periodic requirement enabling each virtual avatar to exist within the virtual environment; defining assets inside the virtual environment; establishing at least one eaming method for each virtual avatar to earn the defined assets; allowing each virtual avatar to earn the defined assets within the virtual environment based in part on the at least one earning method; defining a periodic asset allocation of the defined assets that is equivalent to the periodic requirement by each virtual avatar; and requiring that each virtual avatar within the virtual environment makes the periodic asset allocation to exist inside the virtual environment. In one arrangement, the defined assets comprise digital assets. In one arrangement, the periodic requirement comprises an energy requirement. In one arrangement, the network system comprises a downloadable file to be installed in a computing apparatus, such as a computer, a headset or a cellular phone. In one arrangement the network system is a cloud-based system accessible through the internet by a computing apparatus.

In one arrangement, the virtual environment comprises a digital simulation of a real-world extreme environment wherein human survival is difficult. The periodic requirement comprises a digital simulation of the minimum energy that a real-world user will require to generate, either directly or indirectly, in order to survive in the extreme environment. As just one example, the extreme environment may comprise a celestial environment, like a Mars environment.

In one arrangement, the method further comprises the step of defining a marketplace inside the virtual environment wherein two or more real-world users can interchange the defined assets; defining a relationship between the defined assets inside the virtual environment and a currency, wherein the currency comprises a fiat currency or a crypto currency; and allowing real-world users to purchase or exchange the defined assets by using the currency. The method may further comprise the steps of expiring a virtual avatar within the virtual environment if the virtual avatar does not make the periodic asset allocation that is equivalent to the periodic requirement; and allowing each virtual avatar that has virtually expired within the virtual environment to revive themselves if they make an asset allocation or by obtaining the required assets at the marketplace.

In one arrangement, the method further comprises the step of defining one or more certifications wherein the real-world users learn skills through gamification by interacting with the one or more virtual avatars in the virtual environment. As just one example, the one or more certifications are associated with the knowledge demonstrated by the real-world user while interacting with the one or more virtual avatars. As just one example, the at least one earning method to earn the defined assets consists of earning the one or more certifications.

In one arrangement, the method may further comprise the step of defining virtual user profiles within the plurality of user profiles, the virtual user profiles relating to a virtual avatar that possess a specific certification among the one or more certifications.

In one arrangement, the method may further comprise the step of assembling a first virtual avatar working group within the virtual environment. This first virtual avatar working group collectively works together to earn assets within the virtual environment. In one arrangement, the method may further comprise the step of assembling a second virtual avatar working group within the virtual environment. This second virtual avatar working group collectively works together to earn assets within the virtual environment. In one arrangement, the second virtual avatar working group competes against the first virtual avatar working group to earn assets within the virtual environment.

In one arrangement, the method may further comprise the step of establishing at least one asset earning method for each virtual avatar working group and establishing a distribution method wherein the assets earned by the virtual avatar working group gets distributed among the individual avatars that comprise the virtual avatar working group. The virtual avatar working groups may earn assets by successfully completing a competitive activity.

In one arrangement, the method may further comprise the step of defining a first virtual user profile within the plurality of user profiles. The first virtual user profile relating to a virtual avatar who possess a virtual environment identification, thereby allowing the virtual avatar to assemble a virtual avatar working group.

In one arrangement, the method may further comprise the step of defining a second virtual user profile within the plurality of user profiles, the second virtual user profile relates to a virtual avatar who does not possess a virtual environment identification and therefore is not allowed to assemble a virtual avatar working group.

In one arrangement, a virtual avatar working group comprises a maximum of ten individual virtual avatars.

In one arrangement, the method may further comprise the step of defining a third virtual user profile within the plurality of user profiles. The third virtual user profile relating to a virtual avatar who owns at least one virtual property within the virtual environment.

In one arrangement, the user profiles of the virtual avatars are determined by a type of Non-Fungible-Token that the real-world users own either inside the virtual environment through the virtual avatar or in any other third-party virtual environment.

In one arrangement, a method of providing assets within a virtual environment is disclosed. The virtual environment is generated by a computer program that is executed in a computer network system wherein the method comprises the steps of generating a virtual environment wherein the virtual environment comprises at least one unit of virtual real estate; defining assets for use within the virtual environment; associating the at least one unit of virtual real estate with an ability to generate an amount of the defined assets for use within the virtual environment; linking a conditional Non-Fungible-Token (NFT) to the at least one unit of virtual real estate; coding the conditional NFT to provide a conditional right to use the virtual real estate; defining a usage requirement on the virtual real estate associated with the generation of a minimum amount of the defined assets, purchasing the at least one unit of virtual real estate by a virtual landlord thereby obtaining the right of use of the conditional NFT; and withdrawing the conditional NFT from the virtual landlord if the virtual landlord does not meet the usage requirement on the virtual real estate.

In one arrangement, certain assets are defined assets for use within a virtual environment. As just one example, such assets may comprise digital assets in the form of Fungible Tokens and/or Non-Fungible-Tokens (NFTs). In one arrangement, the Fungible Tokens may comprise a token limited in numbers and also acts as the platform financing token. In one arrangement, the Fungible Tokens comprise internal transactional economic tools, or tokens which are created and burnt by the users while interacting in the virtual environment. In one example, the Non-Fungible-Tokens (NFTs) may comprise a Solid Token and/or a Temporary Token. For example, the Solid NFTs may comprise tokens where the user is the owner of the digital asset and the owner can enjoy, rent or sell such asset as desired. In one arrangement, with a Solid NFT, the virtual environment cannot take back the ownership of such NFT. In one arrangement, a Temporary NFT comprises certain limitations to its use, and: i) it may disappear over time, ii) it may become a Solid NFT is the user performs certain predetermined rules or activities, or iii) it may be a Conditional NFT that is always be linked to a certain activity to be performed by the owner of the NFT

In one arrangement, the at least one unit of virtual real estate is a parcel of virtual land.

In one arrangement, the usage requirement associated with the conditional NFT is to generate the defined asset that consists of at least one virtual building erected on the parcel of virtual land before a certain period of time from the date of the purchase of the conditional NFT.

In one arrangement, the method may further comprise the step of generating one or more virtual avatars representing one or more real-world users wherein each virtual avatar belongs to one of a plurality of user profiles inside the virtual environment. In one arrangement, the defined assets comprise a digital currency in the form ofa digital fungible token. In one arrangement, the fungible token can be duplicated with the same value among each replica, creating two or more digital tokens. In one arrangement, one or more digital tokens can be transferred between two or more virtual avatars wherein the amount of digital tokens that can be generated by the virtual real estate is limited by rules of the virtual environment. In one arrangement, the virtual landlord is a virtual avatar, wherein the virtual landlord can transfer to another virtual avatar one or more of the digital tokens that can be generated by the virtual real estate.

In one arrangement, the method may further comprise the steps of defining a conversion currency that is different from the digital tokens and that comprises a flat currency or a crypto currency and defining a relationship between the digital tokens and the conversion currency. The method may further include the step of defining a marketplace wherein two or more real-world users can interchange the digital tokens or can purchase the digital tokens by using the conversion currency.

In one arrangement, the method may further comprise the step of defining a periodic asset allocation of the defined assets that is equivalent to the periodic requirement by each virtual avatar and requiring that each virtual avatar within the virtual environment makes the periodic asset allocation to exist inside the virtual environment. In one arrangement, the periodic asset allocation is a periodic allocation of digital tokens and the one unit of virtual real estate generates at least the periodic allocation of digital tokens required for one virtual avatar to exist inside the virtual environment.

In one arrangement, the periodic allocation of digital tokens is a digital simulation of the minimum energy that a real-world human will require to generate, either directly or indirectly, in order to survive in a real-world scenario.

In one arrangement, the at least one unit of virtual real estate comprises a virtual power generation facility and the virtual power generation facility comprises an ability to generate an amount of power units in the form of the digital tokens for use within the virtual environment.

In one arrangement, a method of analyzing interactions within a virtual environment comprises the steps of creating a virtual environment as a virtual representation of a real-life system; generating a plurality of virtual avatars representing one or more real-world users; and organizing a first avatar working group comprising a first plurality of virtual avatars. The method further comprises the steps of organizing a second avatar working group comprising a second plurality of virtual avatars; creating immersive experiences amongst the plurality of virtual avatars; and monitoring a first set of interactions between the first plurality of virtual avatars.

The method may further include the step of monitoring a second set of interactions between the second plurality of virtual avatars; monitoring a third set of interactions between the first avatar working group and the second avatar working group; and analyzing the first, the second and the third set interactions between the plurality of virtual avatars as they interact with one another within the virtual environment.

In one arrangement, the method further comprising the step of creating one or more conflict opportunities between the plurality of virtual avatars.

In one arrangement, the real-life system comprises an extreme environment.

In one arrangement, the virtual environment comprises a digital twin of the real-life system. In one arrangement, the result of analyzing the first of interactions, the second set of interactions, and the third set interactions produces data on social and/or behavioral sciences. This data will prove fruitful as it will probably provide certain insights and potential societal interactions on how to change or how to improve the real-life system.

In one arrangement, the invention further comprises the step of defining one or more certifications wherein the real-world users learn skills through gamification by interacting with the one or more virtual avatars in the virtual environment. The one or more certifications may be associated with the knowledge demonstrated by the real-world user while interacting with the one or more virtual avatars; defining assets inside the virtual environment that comprise a digital currency in the form of a digital fungible token wherein the fungible token can be duplicated with the same value among each replica, creating two or more digital tokens; and establishing at least one earning method for each virtual avatar to earn the digital tokens, wherein each virtual avatar can earn the digital tokens based in part on the earning method.

In one arrangement, the at least one earning method to earn the digital tokens comprises the additional process step of earning the one or more certifications and the one or more digital tokens can be transferred between two or more virtual avatars.

In one arrangement, non-transitory computer-readable medium having one or more computer programs stored therein operable by one or more processors to generate a virtual environment, the one or more computer programs comprising a set of instructions that, when executed by the one or more processors, cause the one or more processors to perform the operations of generate one or more virtual avatars representing one or more real-world users; generate a virtual environment wherein each virtual avatar belongs to one of a plurality of user profiles; define a periodic requirement enabling each virtual avatar to exist within the virtual environment; define assets inside the virtual environment; establish at least one earning method for each virtual avatar to earn the defined assets. Further generated operations may also include allow each virtual avatar to earn the defined assets within the virtual environment based in part on the at least one earning method; define a periodic asset allocation of the defined assets that is equivalent to the periodic requirement by each virtual avatar; and require that each virtual avatar within the virtual environment makes the periodic asset allocation to exist inside the virtual environment.

In one arrangement, the computer-readable medium comprises a cloud based medium; wherein the virtual environment is a virtual reality environment; and wherein the define assets are backed by blockchain technology.

The features, functions, and advantages can be achieved independently in various embodiments of the present disclosure or may be combined in yet other embodiments in which further details can be seen with reference to the following description and drawings.

The foregoing summary of the present disclosure with the preferred embodiments should not be construed to limit the scope of the present disclosure. It should be understood and obvious to one skilled in the art that the embodiments of the disclosure thus described may be further modified without departing from the spirit and scope of the disclosure.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a perspective view of computer network system for creating computer-based simulated or virtual environments, according to an example embodiment;

FIG. 2 illustrates a method or process for creating a virtual environment generated by a computer program that is executed in a computer network system, such as the computer network system 100 illustrated in FIG. 1;

FIG. 3 illustrates a method of providing assets within a virtual environment, the virtual environment generated by a computer program that is executed in a computer network system, such as the computer network system illustrated in FIG. 1;

FIG. 4 illustrates a method of analyzing interactions within a virtual environment created by a computer network system, such as the computer network system illustrated in FIG. 1;

FIG. 5 illustrates exemplary virtual users or virtual avatars for use within a virtual environment, such as a virtual environment created by the computer network system illustrated in FIG. 1; and

FIG. 6 illustrates an exemplary floor plan of a virtual apartment or virtual residence for use within a virtual environment, such as a virtual environment created by the computer network system illustrated in FIG. 1.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

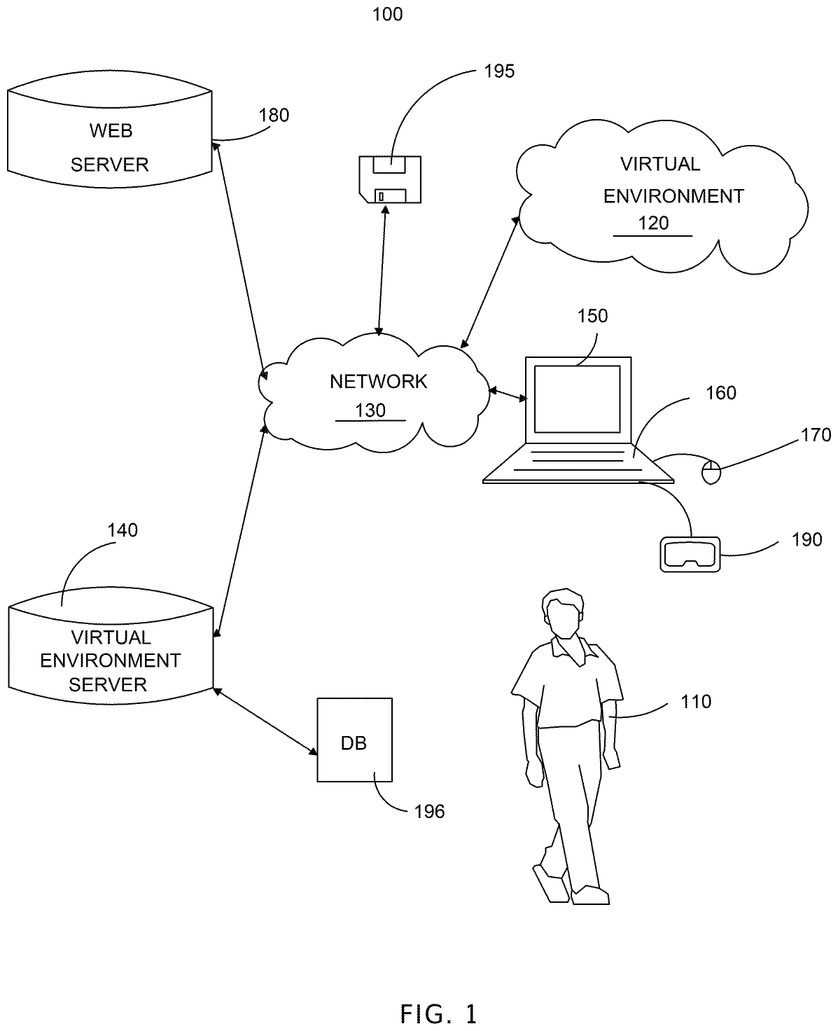

FIG. 1 illustrates a networked computer system 100 that enables one or more real life user 110 to virtually access a virtual environment 120, such as a virtual world or a virtual universe. Access to such a virtual environment 120 may take place via a system network 130. Such a network 130 may comprise the Internet and/or World Wide Web.

The networked computer system 100 comprises at least one virtual environment servers 140. The virtual environment server 140 is accessible via a software that is downloadable into a computing apparatus 150 or, alternatively via the Internet, for example, by way of one or more domain names. In one arrangement, the virtual environment server 140 hosts one or more virtual environments, such as the illustrated virtual environment 120. Real life user 110 interacting with these virtual environments 120 can interact virtually with regard to real life activities within these environments. The one or more virtual environments allow for user interactions that can correspond to real life activities including, but not limited to, working, meeting, competing, traveling, building, designing, creating, attending events, and shopping.

Returning to FIG. 1, the system 100 further comprises a computing apparatus 150. This computing apparatus 150 is configured to communicate with a system for providing access to a virtual environment 120, preferably via wireless, a wired network, or with a software installed in such computing apparatus, such as the system network 130. In one arrangement, the computing apparatus 150 comprises a network computing apparatus, a tablet, a virtual reality headset, a laptop computer, or other similar computing device, such as a handheld computing device such as a smartphone. In one arrangement, the computing device also includes software for browsing the Internet and three-dimensional environments. In one arrangement, the computing apparatus 150 comprises data storage 160 such as, for example, a magnetic disk drive and magnetic disk, or a ROM drive. As those of ordinary skill in the art will recognize, alternative storage devices may be used as well.

The system further comprises one or more input and output devices 170. For example, input and output devices 170 may comprise an input device such as a keyboard, mouse, or touch pad, that may be connected to the computing apparatus 150 via a cable or through any wireless technology. The computing apparatus 150 and the output devices 170 may be one single element that serves both purposes. In addition, AR (augmented reality), VR (virtual reality) eye ware or a VR head gear 190 may also be used to enable a real user to immersively experience the virtual environment. The VR headset may be connected to the computing apparatus 150 with a cable or through any wireless technology. The computing apparatus 150 and the VR headset 190 may be one single element that serves both purposes.

In one arrangement, the system network 130 comprises the Internet or the World Wide Web 180. In addition, system network 130 may comprise a wide area network (WAN) capable of servicing one or more users of the system. Although the connections between user computing apparatus, communications network, and system are shown as being a physically tethered system, those of ordinary skill in the art will recognize that such connections are not typically direct connections, as in the manner in which an end user typically connects to an Internet site through one or more nodes, and that such connections need not be continuously available. Moreover, it will be understood that such connections need not be wired connections and may comprise wireless connections in whole or in part.

In an embodiment as shown in FIG. 1, the system 100 provides access to a virtual environment 120 as these environments are described and disclosed herein. It will be understood that although a single computing apparatus 150 is illustrated, it is intended that the system 100 be accessible to and accessed by a plurality of computing devices 150 at the same time, perhaps hundreds of thousands of computing devices. In addition, the system 100 also generally includes a web server 180 for serving the web pages that drive the user's 110 interaction with the system 100.

In one preferred arrangement, to access the virtual environment 120, an executable tile must be downloaded to the user's computing apparatus 150. For example, this computing apparatus 150 may comprise a headset, a play counsel, a mobile device, a desk top computer or the like. The user 110 will therefore have that downloaded file in their local set and then this file allows the user to access the virtual environment 120. On some embodiments, the entire virtual environment 120 might be already included in the downloadable file without the need for the computing apparatus 150 to connect to the internet. However, one disadvantage of such a system is that in order to gain access to the virtual environment 120, the user 110 is required to have hardware to be able to experience the entire immersive virtual environment 120. Another limitation of such a download system that requires a downloaded tile is that the tile usually needs to be individualized based on the computing apparatus 150 that will be downloading the file. For example, if the file is to be downloaded to a desktop computer, the file must be individualized to desk top computers. Similarly, if the file is to be downloaded to a mobile device such as a mobile phone or a Professional Data Assistant (PDA), the file must be individualized to mobile devices.

In another preferred arrangement, rather than download a device dependent executable file, the user 110 can simply enter the virtual environment 120 by way of an URL. This URL will then rum so that the user can then experience the entire immersive environment simply by gaining access to the virtual environment by accessing the URL. URL stands for Uniform Resource Locator. Here, this URL is nothing more than the address of a given unique resource on the Web. This URL will point to a unique resource allowing virtual environment access. With such an URL based system, by accessing the URL, the URL will then detect what type of downloading device that a user is using to access the platform (e.g., tablet, desk top computer mobile device, VR headset etc.). Once the downloading device is detected, the virtual environment is created through cloud renderization and will be properly enabled for that particular device without the user having to download any type of executable file.

One advantage of such an URL based downloading system is that updates can occur seamlessly and quickly, without the user having to download any new files. In addition, with such a URL based downloading system, there is no need for the user to have to allocate storage capacity on the user's downloading device and the renderization of the virtual environment is provided remotely in the cloud.

In addition, the system 100 preferably comprises one or more virtual environment servers 140. The system 100 further comprises a storage database 195. In one system, the virtual environment server 140 and a cloud data base (DB) 196 are interconnected to host the virtual environment 120. In one method of operation, the user 110, using user computing apparatus 150, accesses a web site provided by the web server 180 of system 100. The web site preferably provides access to a graphical user interface (GUI). Importantly, this GUI allows a user in the form of an avatar to access a virtual environment 120.

As another example, a user may be involved in an interaction that involves working at one of the businesses that exists virtually within the virtual world or universe established by the virtual environment server 130. As another example, a user may own digital assets, such as a parcel of land or real estate within the virtual environment. This parcel of land may comprise a commercial structure like a business or store. This parcel of land may also comprise a personal virtual environment like a home, condo, or apartment.

In one arrangement, the virtual environment is configured to provide multi-player simulation. The platform represents a system that will model the complex responses associated with creating a new society based on information and rules to be determined by the virtual environment's community. In one exemplary arrangement, the new society is one that is created within a harsh environment. In one preferred arrangement, the citizens of the virtual environment will vote for the most relevant decisions for how the virtual environment will be governed. In one arrangement, the virtual environment will utilize at least one digital currency to quantify and measure various living conditions and indicators within the virtual environment.

In one preferred arrangement, the virtual environment comprises an extreme virtual environment, such as a celestial environment. For example, such a celestial environment may be a Mars environment wherein the environment is extremely harsh. Because of this extremely harsh environment, survival within such an environment would be easier if those operating within the environment would work together as a group to put forth a community collaborative effort, wherein such group may be a working group or clan to perform team roles, jobs or activities inside the virtual environment. In one example, the maximum number of members per working group may be limited to certain number of avatars. However, those of ordinary skill in the art will recognize alternative harsh environments or number of members per working group may also be utilized within the platforms as described herein.

As just one example, the virtual environment may comprise a digital simulation or a digital twin of a real-world extreme environment wherein human survival is difficult. The human difficulty may turn on certain challenges that are virtually presented within the virtual environment and may relate to, for example, the survival, the existence, social interactions, and/or community governance. For example, the digital twin may be a replica of an extreme or harsh environment, such as the environment of Mars. Those of ordinary skill in the art will recognize that alternative harsh environments may also be utilized such as a dessert environment, the frozen tundra of Antarctica, the surface of the moon, a post-apocalyptic world after a nuclear war, or perhaps even a floating city after a global climate change disaster.

As explained in detail herein, each virtual avatar existing within the virtual environment will exist as a member of a given profile. In one preferred arrangement, the virtual avatar can only belong to a single profile at a given time but may change profiles, from time to time. In one preferred arrangement, the environment defines a plurality of different profiles. As just one example, there might be three (3) different types of avatar profiles wherein, in one arrangement, these profiles are defined as Citizens, Explorers, and Travelers. These profiles will find numerous missions to create a self-sufficient life in an extreme environment, such as Mars. Additional profiles may be provided based on the skills or roles of each avatar. As just one example, the additional roles may be a farmer, miner, scientist, entrepreneur, artist, etc. The profiles may be associated with different certifications that the real user must earn to associate a particular skill to their avatar. Such certifications may be connected to the education industry because the real life users “learn by doing” in the simulated reality of the virtual environment, and can earn actual certifications that are useful for their avatar roles in the virtual environment and for the physical lives of the real life users. The profiles accommodate a diversity of interests inside the virtual community, ranging from participate-to-earn, to content creation, education and training, research opportunities, and investments in digital assets and art on the virtual environment.

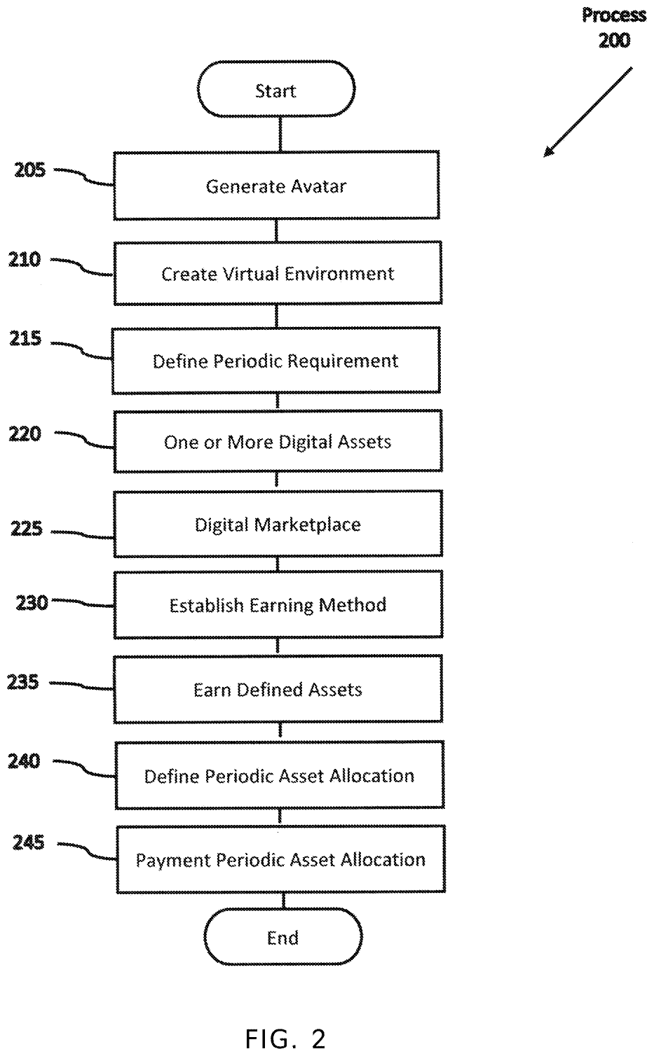

FIG. 2 illustrates a method or process 200 for creating a virtual environment generated by a computer program that is executed in a computer network system, such as the computer network system 100 illustrated in FIG. 1. As illustrated, this method 200 begins at step 205 and comprises the initial step of generating one or more virtual avatars representing one or more real-world users.

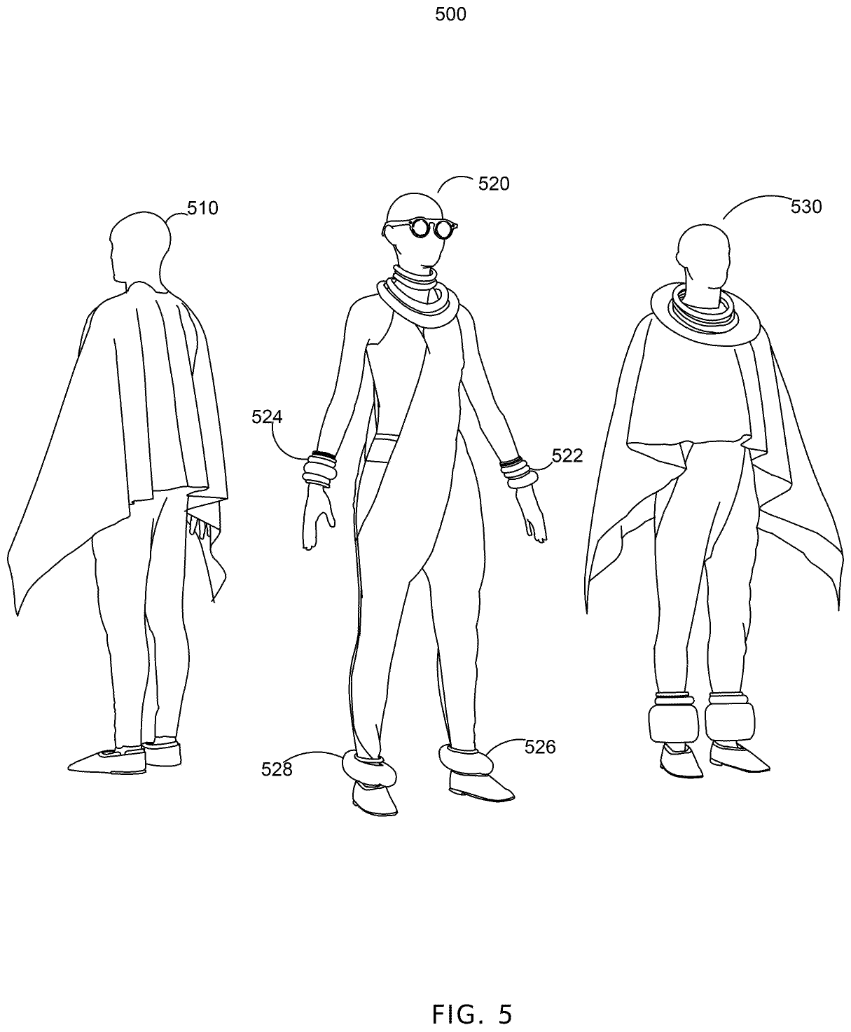

For example, in this virtual environment, one or more virtual communities may exist with various different types of avatars 500. For example, FIG. 5 illustrates exemplary virtual users or virtual avatars for use within a virtual environment, such as a virtual environment created by the computer network system illustrated in FIG. 1. As illustrated, three avatars are illustrated: a first avatar 510, a second avatar 520 and a third avatar 530.

As illustrated, the first avatar 510, a second avatar 520, and a third avatar 530 are generally outfitted with virtual clothes and/or accessories for use within virtual environments, preferably virtual harsh environments. In such harsh environments, like Mars or the Moon, since there are limited resources, the clothing and other accessories that are worn by these avatars 510, 520, and 530 need to take into account that resources within such harsh environments are generally limited. Therefore, the virtual environment will provide for avatars that use clothing and other types of accessories that comprise long term clothing or clothing that can last a long time.

Because resources and materials in an extreme environment are scarce, in one arrangement of a virtual environment that aims to be a digital twin of such harsh environment, the preferred clothing may comprise a unisex type of clothing, creating an androgen fashion inside the virtual environment. Such clothing types may be used to reduce manufacturing costs and limit the types of clothing that is fabricated since material is scarce. Such unisex styled clothing may be referred to as gender-neutral, androgynous, or unisex styled clothing. Such clothing types can be used independently where the user behind the avatar is either male or female.

Where gender neutral clothes are used, avatars may also use certain accessories. In one arrangement, these accessories may perform multiple functions. For example, these accessories may provide the avatar an easier adaption to the virtual environment, especially where the virtual environment comprises a harsh environment. These accessories may also provide each avatar with a sense of identity.

For example, as can be seen from the first avatar 510 and the third avatar 530 illustrated in FIG. 5, the avatars 510, 530 may be provided with capes that can be used where these avatars can utilized the no gravity environment on Mars to jump and “fly” from point to point.

Other virtual accessories may also be provided. As just one example, the second avatar 520 is provided with one or more accessories. As an example, this second avatar 520 is provided with accessories on its first or left wrist 522 as well as on its right or second wrist 524. A first accessory is provided on the first or left wrist and a second accessory is provided on the right or second wrist. In one preferred embodiment, aside from providing a certain fashionable statement, these wrist accessories may comprise weights, that can prove beneficial for certain low gravity harsh environments. For example, in low gravity locations, such as the Moon, Mars or even under-the-ocean future cities, the accessories may comprise of weights to adapt the movements of a person closer to Earth conditions. In another example where the extreme environment is a cold location, such as Antarctica, the accessories may radiate heat to maintain the body temperature of the avatar that represents a human being forced to survive in such a difficult environment.

Referring now to the first avatar 510, this first avatar 510 may comprise an avatar body that must become accustom to a low gravity environment Note that the second avatar 520 also has a first ankle accessory 526 and a second ankle accessory 528. Like the first and second wrist accessories, the first and second ankle accessories may also comprise wearable weights. These wearable weights can be configured or designed so as to allow the user and avatar to adjust to the low gravity nature of the harsh environment.

In one arrangement, the clothes of the avatar may represent a user profile of the avatar. As just one example, in FIG. 5, perhaps the first avatar 510 wearing a type-A cape 512 is represented by a first user profile with the virtual environment, such as a citizen. And the second avatar 520 who is not wearing a cape but is wearing reflective glasses may comprise a second type of user profile within the virtual environment, such as an explorer. Similarly, the third type of avatar 530 who is wearing similar type of clothing as the first avatar 510 but whose clothes are a different color and who is also wearing a necklace accessory, may belong to a third user profile of avatars such as a group known in the example as the travelers. As those of ordinary skill in the art will recognize, alternative clothing and group type designations may also be utilized.

Next, returning to FIG. 2, the process 200 proceeds to step 210 where the system creates or generates a virtual environment wherein each virtual avatar belongs to one of a plurality of user profiles. In one preferred arrangement, the plurality of user profiles comprises three different types of user profiles. In one preferred arrangement, these three user profiles may be referred to as Citizens, Explorers, and Travelers. Virtual avatars can move from one user profile to the next. In other words, if a virtual avatar is first a Traveler, the virtual avatar can perform one or more functions or activities that allow the virtual avatar to become either an Explorer or a Citizen. However, in one preferred arrangement, a virtual avatar can belong to only one type of user profile at a given time. As those of ordinary skill in the art will recognize, a different number of user profiles may be used and along with different user profile configurations and definitions.

In one arrangement, Citizens are those virtual users existing within the virtual environment that own at least one specific type of parcel of virtual real estate, which in one example is called a virtual apartment. Such virtual real estate ownership confers certain ownership rights or benefits to the Citizen or the owner. For example, such a Citizen or owner may own an apartment or condo in a harsh environment, like Mars. As just one example, such an apartment can be purchased complete with virtual items, such as virtual furniture and other virtual items, like virtual artwork. One way to purchase such an apartment is through the use of a Non-Fungible Token (NFT), preferably using blockchain proof of stake technology. Alternatively, this purchase may be made by fiat or perhaps even by ways of the environment's digital assets, in the example called power units.

Citizens also have a certain degree of voting powers and in this way have an opportunity to take part in the governance of the virtual environment. As an example, the citizens may comprise a Decentralized Autonomous Organization (DAO) as a community with no central authority. Therefore, they may have a right to decide how neighborhoods, cities or settlements inside the virtual environments will be structured, governed, or operated They may also have a right to determine how the environment is zoned or parceled for virtual businesses and parcels are zoned for further development. Importantly, Citizens also have the right to create their own working group or clan.

In one preferred arrangement, these voting rights or powers may be related to how many virtual apartments they own. As just one example, these virtual property owners will be provided with one vote for each of the virtual apartments that they have purchased. As just one example, if a virtual user were to purchase three virtual apartments, this virtual user would have a total of three votes in one arrangement, the governance of the virtual environment may set a maximum number of properties that can be owned for each virtual user. As just one example, there might be a maximum of twenty (20) virtual apartments per real user or per digital wallet. As such, in this arrangement, the digital platform supporting the virtual environment may control in part the power or the voting rights of certain or all of the individuals virtual residing in the environment. In one preferred arrangement, this virtual real estate, such as the virtual apartments or any other virtual land or built space, can be purchased with the primary digital asset of the virtual environment or it may be purchased with fiat.

There may be a second type of user profile and this second user profile may be referred to as the Explorer. Explorers are those users that own a platform or virtual environment identification. This platform identification functions similar to a governmental identification, such as a social security card or a state driver's license. Explorers are those avatars associated with real users that are now part of the virtual system where the user has a digital or cryptocurrency wallet that is connected to the platform's digital exchange and such digital wallet owns a specific virtual identification that can be purchased in a digital exchange that may comprise a digital marketplace as will herein be described in detail. In this manner, the user can trade digital assets and tokens and can become an active participant within the community. In one arrangement, Explorers will have certain qualified voting rights or voting powers. However, in one preferred arrangement, Explorers will not have as much voting rights or powers as the platform's Citizens. Explorers will also have the right to create their own working group or clan.

The third type of user profile in the example is the Traveler. In one preferred environment, Travelers do not possess any type of ownership right or NFTs. The platform periodically allocates to each Traveler a certain amount of internal token, or power units, as described in detail herein. For example, the platform may allocate to every Traveler operating within the virtual environment a certain amount of power units every month. Travelers do not have the right to create their own working group or clan. However, Travelers do have the right to join a working group or clan, but they are required to be a member of a working group at one particular time. In such a situation, in order to join a particular working group, the Traveler must convince the founder or leader of a working group as to why that Traveler should be allowed to join this particular working group. The particular working group may decide to allow the Traveler to join their working group based on the skills or experience the Traveler may provide.

In one preferred arrangement, when joining the platform or beginning to operate within a virtual environment, the platform governance will initially allocate to the Traveler a certain number of internal tokens, or power units. In one example, the platform governance will allocate the Traveler enough power units for the first month of virtual environment existence. But after this first month, the Traveler must purchase the required power unit requirement that must be paid in subsequent months. Alternatively, in order to continue operating within the virtual environment, the Traveler must utilize one of the multiple earning methods so as to earn additional power units for future monthly payments.

Returning to the process 200 illustrated in FIG. 2, the process proceeds to step 215 where the system defines a periodic requirement. This periodic requirement may be defined as a requirement that enables each virtual avatar to exist within the virtual environment. Different virtual environments may have different defined periodic requirements. Generally speaking, this periodic requirement is a requirement of the avatar or real user that allows this avatar or real user to exist in the harsh environment created within this virtual environment. As just one example, such a periodic requirement may be defined as an energy requirement. And in one preferred arrangement, this energy requirement may be a calculated value that approximates the amount of energy that is required for this virtual avatar to exist within the harsh or extreme virtual environment.

In one preferred arrangement, this periodic requirement will be the same requirement for each virtual avatar residing within a given virtual environment, irrespective of the avatar's user profile type. In an alternative arrangement, this periodic requirement, will not be the same requiremen for each virtual avatar, within a given virtual environment. As just one example, the periodic requirement may be determined by the user profile of the virtual avatar. As just one example, the periodic requirement of a Citizen might be different than the periodic requirement of an Explorer. And this Explorer's periodic requirement might be different than the periodic requirement of a Traveler.

As just one example, the periodic requirement represents a digital simulation of the minimum energy that a real-world user will require to generate, either directly or indirectly, in order to survive in the extreme environment. This periodic requirement may comprise an energy requirement that is calculated to exist in a celestial environment, such as a Mars environment.

In one preferred arrangement, this periodic requirement may be termed a power unit. Therefore, in one arrangement, the periodic requirement may comprise a set number of power units that a real-world user may require to generate or allocate or payout to continue to exist within a given extreme virtual environment. In one arrangement, this periodic requirement is static and does not change over time. In another arrangement, this periodic requirement is dynamic and may change over time. For example, this periodic requirement may change over time to take into account the future power generation developments occurring or taking place within the virtual environment as the virtual community builds settlements and becomes more efficient with their resources. As just examples, the virtual population of the power generation capabilities of the virtual environment may have an effect on how the periodic requirement is computed or determined. As just one example, as the virtual power generation capabilities of the virtual environment increase over time, perhaps the periodic power requirement per virtual avatar decreased over time as well. As an additional example, if one or several members of the community find a more efficient way to farm in an extreme environment, the cultivation of crop may require less energy and therefore, the entire virtual community will require less energy, or power units, to survive. In some examples, the community might need to acquire or vote to license the technology developed by the inventors to reduce the periodic power requirement, or power units, inside the digital twin or digital environment.

Next, the process 200 proceeds to step 220 where the system defines one or more digital assets to be utilized inside the virtual environment. In one arrangement, these defined assets may comprise digital assets such as cryptocurrencies and/or non-fungible tokens (NFTs). These assets may be used for various purposes within the virtual environment.

For example, in one arrangement, these defined assets may comprise two types of digital assets or fungible tokens to be used in one virtual environment arrangement. For example, a first type of token may comprise a type of platform financing token, with which users can become an investor in the virtual fabrication, construction, or manufacturing of a particular virtual environment. In one arrangement, this first type of token (e.g., Token Type A) may comprise a token having a limited supply in quantity, may have financial value and might be a fungible crypto token, such as ERC-20 or alike. That is, the governance platform may decide to cap the overall supply of the first type of token within the virtual environment. In one preferred arrangement, this first type of limited digital asset can be converted back and forth to fiat currency and such an exchange can take place via a digital asset marketplace, as described in detail herein.

The second type of fungible tokens (e.g., Token Type B) may be represented as internal transactional economic tools that simulate a new society within the simulated virtual environment. In one preferred arrangement, these transactional economic tools may be a periodic requirement that may be represented, as an example, as power units. The generation of power units will provide the resources for the community's development and the virtual users' subsistence. These transactional economic units, or power units, can be earned by individual avatars and/or by the working groups as these working groups compete against other working groups during certain interactive activities, such as mission activities as described herein.

At the same time, these transaction economic tools will also be burned in the operation of the communities on the harsh virtual environment. For example, by burning these economic tools it is meant to mean the process of effectively taking those tokens out of circulation within the virtual environment. As just one example, these power units might be burned as they are paid periodically by each avatar to the platform governance. Therefore, by burning these power unit tokens, the platform governance is reducing the total supply of these tokens and in some cases may even increase demand for these tokens as well. As just another example, as avatars may represent a digital human surviving in an extreme environment, the power unit token (Token Type B) may be burnt by each avatar just by being in the virtual environment, as obtaining oxygen, food, and other life-support systems need energy, which in one example is directly associated to the periodic requirement that a power unit represents.

In one preferred virtual environment arrangement, users can work to earn these power units to not only to serve but to enjoy certain things within the environment: clothes, entertainment, artwork, other needs or wants. However, if a virtual avatar does not work or rather if a virtual avatar does not take part in any environmental activities to earn these power units within the environment, the virtual avatar may not be able to pay their periodic power unit requirements. As a consequence, non-payment of these power unit (Token Type B) requirements and therefore the avatar will be virtually terminated within the environment, as a virtual representation of dead inside the virtual environment.

Alternatively, for those that want to reside within the simulated virtual environment and do not want to work, or perhaps do not need to work, they can purchase these power units within the marketplace, which represents a secondary market for these digital assets.

In one arrangement, the process 200 illustrated in FIG. 2 also includes the step 225 of defining a digital asset marketplace inside the virtual environment. In such a marketplace, this is where two or more real-world users can interchange these defined assets: the platform financing token (Token Type A) and the internal transactional economic tool (Token Type B) Such a marketplace may operate as a cryptocurrency exchange or similar type of service. As just one example, such a marketplace will allow users to exchange the platform financing token for the internal transactional economic tools. For example, Token Type B may be available for purchase in the marketplace by paying with Token Type A, and vice versa.

In one arrangement, the process 200 illustrated in FIG. 2 may also comprise the step of defining a relationship between the defined assets, such as fungible or non-fungible tokens, inside the virtual environment and a currency. As an example, such a currency may comprise a fiat currency or a cryptocurrency. In one arrangement, such an established marketplace will enable or allow real-world users operating within the virtual environment to purchase or exchange the defined assets by using the currency. The marketplace may also enable other asset exchanges and asset allocations as well.

As just one example, the marketplace may allow users to stake some of their digital assets so as to allow them to earn further assets based upon their staked allocated assets With staking, investors will lock their digital assets up for a stated period of time to help support the operation of the virtual environment's blockchain. In return for staking these digital assets, investors can earn back digital assets in return. In one preferred arrangement, the virtual environment utilizes a blockchain premised on a proof of stake consensus mechanism (PoS) although it may use proof of work consensus or any other blockchain technologies Under this PoS system, community participants who want to support the blockchain by validating new transactions and adding new blocks must “stake” set sums of these digital assets.

Returning to FIG. 2, after step 225, the method 200 proceeds to step 230 where the process establishes at least one earning method for each virtual avatar to earn the defined assets. As noted herein, in one preferred arrangement, the virtual environment will utilize one or more types of digital assets, either fungible or non-fungible. The system will establish one or more methods on how real users within the virtual environment can earn these digital assets within the virtual environment.

Within the virtual environment, there are multiple methods or ways that tokens (either Token Type A or Token Type B) can be earned. As just one example, users may earn or generate power units (Token Type B) by joining a working group, by content generation, or by selling virtual items, such as non-fungible-tokens (NFTs), within the virtual environment. In addition, real users can also earn tokens by selling their services or skills to others as an advisor or subject matter expert within the virtual environment. For example, if a virtual user is an expert in rocket technology and a working group is working on a mission that requires an expert in rocket technology, this user could offer his or her technical expertise at a cost to this working group. As a result, this expert may be paid in Token Type A or in Token Type B, and then the expert can convert them as needed inside the marketplace. However, as previously noted, in one example, each real user can belong to only one working group at a given time.

Users can also earn tokens (either Token Type A or Token Type B) by owning certain types of virtual property or real estate and renting this virtual property out. Owning digital assets, such as virtual property, and using this virtual property to generate something that can be sold in the virtual environment or generate power units (Token Type B) that can then be sold in the virtual environment in the marketplace. For example, a user may purchase specific virtual land that allows, as per the rules and urban zoning of the virtual environment, to build an energy plant. Therefore, after hiring other members to build such a plant, the owner may be able to create power units (Token Type B) to offer back to the community, either selling them or offering them in return of work or expertise. In such a sample, as all avatars need power units to survive, the owner of the power plant will earn passive income, by earning power units (Token Type B) that can be used in the virtual environment, or that can be converted in the marketplace to Token Type A (with a limited number of tokens available in the virtual environment), and then converted to fiat currency. In another example, a user may purchase digital land that is associated with farming land. In such a case, such user may need to buy energy from the power plant owner to grow the crop and hire other avatars to harvest the crop. However, once the crop is ready, the farmer will be able to offer the food to the virtual community in return of power units, as all avatars will need food to survive, as part of their periodic requirement allocation.

In one preferred arrangement, the virtual environment may create or define a plurality of different token earning mechanisms such as missions or virtual challenges. In one preferred arrangement, there may be many types of missions or virtual challenges leading up to various types of earning opportunities. In one preferred arrangement, the missions will be defined by the virtual environment platform. In one preferred arrangement, one or more missions may be related to construction related activities within the virtual environment. As just one example, a construction related mission may be directed to creating a mission or creating a challenge to design and create a cost-effective power generation plant or a farming facility. Another construction related mission may be directed to a challenge to design and build a virtual building structure or logistical hub.

Missions may also comprise periodic missions wherein the same mission occurs periodically within the virtual environment. For example, the same mission may be issued once a day, once a month or perhaps twice a month.

Other types of missions may be created by a first working group of avatars. And then this first working group of avatars would present a challenge to another or second working group of avatars so as to solve or work on this mission. For example, the first working group of avatars may challenge a second working group of avatars to solve a challenge or puzzle and this solution must be provided within a certain time frame. These working groups of avatars can then bet amongst themselves. Other missions may relate to industrial or expert proposals.

For example, these missions may be events or challenges where the successful completion of such a mission will earn the participating user a certain amount of power units (Token Type B), or even Token Type A. Missions may comprise a treasure hunt or escape rooms where virtual avatars compete with one another to earn a prize wherein the prize is paid out in digital assets, such as paying out power units. Other missions may relate to construction or engineering challenges where virtual avatars compete with one another to come up with a solution to a construction or engineering challenge.

Other missions may relate to a farming or manufacturing requirement where certain items will be required to be made or manufactured or perhaps a farming requirement where a certain food items will need to be planted, grown, harvested and/or processed. Other missions may relate to puzzles to be solved or intellectual challenges.

After establishing the earning methods at step 230, the method 200 illustrated in FIG. 2 proceeds to step 235 where the system allows each virtual avatar to earn the defined assets within the virtual environment based in part on the at least one earning method. In one preferred arrangement, earnings within a successful working group are not distributed equally among all the various members within the working group. For example, under one proposed distribution method, earnings distribution is based on a hierarchy within the working group. In other words, the distribution of earnings within a working group may be based on a particular real user's characteristic, such as the real user's profile.

For example, in one proposed earnings distribution method, Travelers within a successful working group will receive one token (Token Type A or Token Type B) whereas a Citizen within this same successful working group will earn three tokens for every one token that is paid out to a Traveler. And with such a proposed earnings distribution method or system, an Explorer will earn 1.5 tokens for each token that the Traveler will earn. Therefore, in such a proposed token distribution method, the Citizen would maximize their token earnings if the remainder of the his or her working group contained only Travelers.

In one preferred payment distribution method, the paid-out earnings amounts are may also be a function of the total number of members within the working group. In one preferred payout method, there is an incentive for working groups to socialize and work collectively within large groups so that working groups are always structured to have the maximum number of participants. In one arrangement, there might be one Citizen, or one Explorer, and then have the remainder participants be Travelers.

Returning to FIG. 2, the process 200 proceeds to step 240 where the process defines a periodic asset allocation or rather a periodic payment of the defined assets that is equivalent to the periodic requirement by each virtual avatar. In one preferred arrangement, this periodic asset allocation enables the avatar real world user to exist in the virtual environment. As just one example, this periodic asset allocation may comprise the payment of a certain number of power units and these power units will be paid to the virtual environment.

The process 200 then proceeds to step 245 where the system requires that each virtual avatar within the virtual environment makes the periodic asset allocation. In one preferred arrangement, this allocation is a condition precedent in order for the virtual avatar to exist within the virtual environment. If this periodic asset allocation is not allocated on a periodic basis as required by the virtual environment, the virtual avatar will no longer be allowed to exist within the virtual environment. The virtual avatar will therefore expire within the virtual environment.

As just one example, this periodic asset allocation may require that each virtual avatar make a daily, weekly, or monthly payment of a certain amount of digital assets, such as power units (Token Type 3). Again, as just one example, each digital avatar existing within the virtual environment may be required to make a monthly payment of a certain amount of digital assets, say 170 power units. Failure to make this periodic allocation may have consequences on the non-paying avatar. And in one situation, these consequences of non-payment may be dire. As just one example, in one arrangement, a user's failure to make such a periodic allocation may result in the termination or expiration of the virtual avatar within the virtual environment. In one example, even if the virtual avatar expires, the real-life user behind the avatar will not lose their digital assets, either fungible or non-fungible, that he or she might own but will not be able to operate in the virtual environment until the periodic allocation has been fulfilled.

However, in one arrangement, this termination or expiration within the virtual environment may be reversible. For example, the process 200 may allow each virtual avatar that has virtually expired within the virtual environment to revive themselves. As just one example, the process 200 may allow a virtual avatar to revive themselves and re-enter into the virtual environment if they make an asset allocation or by obtaining the required assets in the marketplace. However, as those of ordinary skill in the art will recognize, alternative avatar revival methods may also be utilized within the virtual environment as well.

In one potential process step of process 200, the system may further comprise the step of defining one or more certifications wherein the real-world users learn skills through various methods. For example, real-world users may learn skills through a gamification such as by interacting with the one or more virtual avatars in the virtual environment. As just one example, the one or more certifications may be associated with the knowledge demonstrated by the real-world user while interacting with the one or more virtual avatars. The at least one earning method to earn the defined assets consists of earning the one or more certifications. For example, the system may define virtual user profiles within the plurality of user profiles, the virtual user profiles relating to a virtual avatar that possess a specific certification among the one or more certifications.

In one additional step provided within process 200, the process 200 may further include the step of assembling a first virtual avatar working group within the virtual environment. In one preferred arrangement, this first virtual avatar working group may be classified as a team or a clan. Teams and clans are used to achieve collaborative success since operating individually, apart from working in a collective group, in harsh environments would be extremely challenging. In one preferred arrangement, every virtual user within the virtual environment must belong to a virtual avatar working group. This virtual avatar working group may comprise a mix of user types, for example a mix of Citizens, Travelers or Explorers.

In addition, every virtual user within the virtual environment can be selective as to which virtual avatar working group they will join. And in one preferred arrangement, each virtual avatar can only belong to one working group at a time. If a virtual avatar wishes to leave a working group to join another working group for one reason or another, he or she is free to do so at their will.

In one preferred arrangement, this first virtual avatar working group will work as a collective unit and work collectively towards trying to earn assets within the virtual environment. For example, in one preferred arrangement, this first virtual avatar working group will work as a collective unit and work towards trying to earn assets within the virtual environment by competing against other working groups. For example, these competing working groups may work as a collective unit to successfully perform one or more missions as described in detail herein.

In a similar way, the process 200 may also further include the process step of assembling a second virtual avatar working group within the virtual environment. Similar in construct as to the first virtual avatar working group, this second virtual avatar working group will be assembled so as to collectively work together to earn digital assets within the virtual environment. Within the virtual environment, this second virtual avatar working group will compete against the first virtual avatar working group (as well as other virtual avatar working groups) so as to earn assets within the virtual environment. Of course, the virtual environment may have more working groups than just the first working group and the second working groups.

In one arrangement, the virtual working groups operating and then competing within the virtual environment may comprise various sizes. However, in an arrangement, the platform or system may put a cap or a limit on the maximum number of avatars that can be assembled within a virtual group. As just one example, the process 200 may comprise the step of limiting each of the virtual avatar working group comprises a maximum of ten individual virtual avatars. In addition, in one arrangement, the process 200 may comprise the step of limiting the number of Citizens, Travelers, or Explorers that each of the virtual avatar working group may comprise. As just one example, the process 200 may comprise the additional step of placing a limit of allowing only one Citizen to join a particular working group.

The process 200 may further include the process step of establishing at least one asset earning method for each virtual avatar working group. For example, this asset earning method may comprise a first asset earning method whereas the second group may comprise a second earning method that is different than the first asset earning method. Process 200 may further include the step of establishing a distribution method wherein the assets earned by the virtual avatar working group gets distributed among the various individual avatars that comprise the virtual avatar working group.

As noted, the first virtual avatar working group will be competing against a second virtual avatar working group. Of course, there may be a third, a fourth and many other virtual avatar groups competing for the same digital assets. There are many ways that the virtual avatar working groups may earn assets within the virtual environment. In one preferred arrangement, as these various virtual avatar working groups compete with one another, the virtual avatar working groups can earn tokens by successfully completing a competitive activity.

In one preferred arrangement, the process 200 may further comprise the step of defining a first virtual user profile within the plurality of user profiles. As an example, the first virtual user profile may relate to a virtual avatar who possess a virtual environment identification. In one preferred arrangement, this virtual environment identification may allow this virtual avatar to possess certain rights and/or certain obligations within a particular virtual environment.

As just one example, this virtual environment identification may provide a virtual avatar with the right to assemble a virtual avatar working group. Similarly, those virtual avatars who do not possess such a virtual environment identification will not be allowed to assemble a virtual avatar working group that can be assembled to compete against other virtual avatar working groups within the virtual environment.

In one arrangement, there can be many different types of user profiles within the plurality of user profiles wherein these different user profiles have certain different rights and abilities. For example, in one arrangement, the process may at another process step define a second virtual user profile within the plurality of different user profiles.

In one arrangement, the system may comprise the step of defining a third virtual user profile within the plurality of user profiles. In one arrangement, the third virtual user profile may relate to a virtual avatar who owns at least one virtual property within the virtual environment. In one preferred arrangement, each virtual avatar within the virtual environment must always belong to only one of the plurality of user profiles. In one preferred arrangement, the user profile of a virtual avatar may change or may be altered based on certain events. As just one example, a user's profile may change if the user purchases virtual property or sells virtual property.

The user profile for a virtual user may be based on a number of criteria. As just one example, the user profile of a virtual avatar may be determined or may be dictated by a type of Non-Fungible-Token (NFT) that the real-world user possess, owns, and/or has purchased. Possession or ownership of such an NFT may exist either inside the virtual environment through the virtual avatar or via any other third-party virtual environment. Other criteria may be used to determine a user's profile as well.

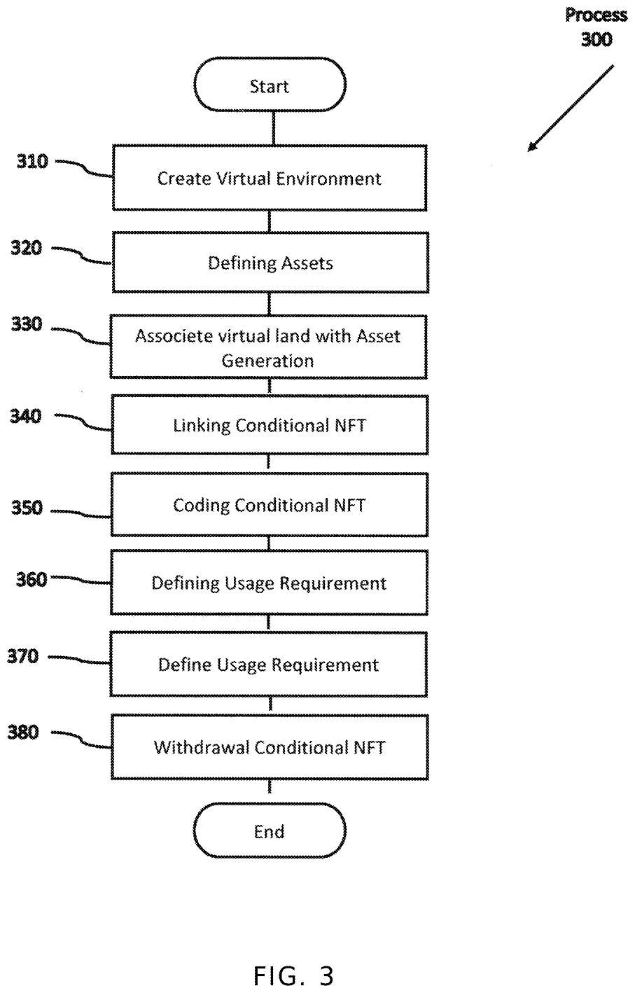

FIG. 3 illustrates a method 300 of providing assets within a virtual environment, the virtual environment generated by a computer program that is executed in a computer network system. For example, the method 300 starts with step 310 by generating a virtual environment wherein the virtual environment comprises at least one unit of virtual real estate. In one preferred arrangement, the virtual environment may comprise a manufacturing facility, a power generation plant, or a form in one preferred arrangement, one of the many types of virtual real estate may comprise a virtual apartment or a virtual condominium.

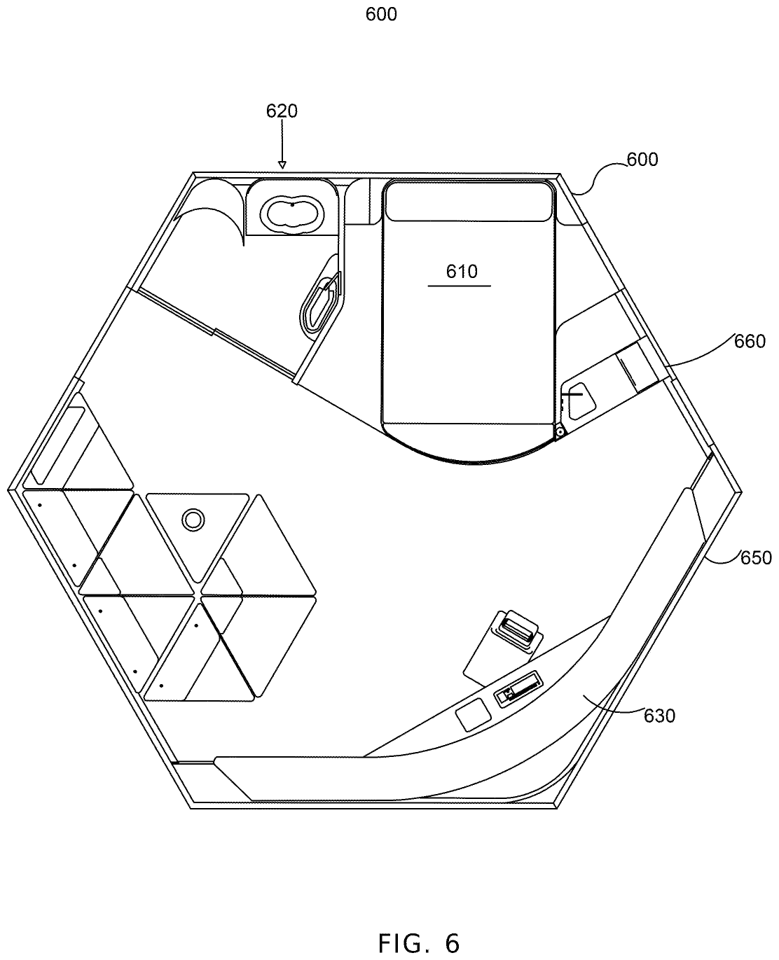

As just one example, FIG. 6 illustrated a floor plan of a virtual apartment 600. As structured, such an exemplary space represents a modular solution wherein such a modular construction is one that is highly scalable. Such environmental structures can prove beneficial for certain types of environments, such as harsh environments. For example, oftentimes in such environments, materials can be scarce so the scalability of certain types structures can prove quite beneficial in these types of environments.

As illustrated, this modular construction 600 may comprise a one bedroom structure like a studio apartment. As illustrated, this one bedroom structure may comprise enough room or space to provide for a bed and related furniture 610. The one bedroom structure 600 may also comprise a bathroom 620 that could include a commode as well as a shower. In one preferred arrangement, such a bathroom 620 may comprise a prefabricated bathroom. The living space 600 may also comprise a kitchenette 640 that is situated adjacent the bedroom structure 610. This living structure 600 may also include a sofa or chair positions along a third wall where a working station or office space 630 is also provided.

As illustrated, such a modular construction 600 can utilize the advantages of a six sided or a hexagon like structure. Such a multi-sided structure allows such modular structures to be easily connected or placed adjacent one another. As just one example, a second modular structure may be configured along this a first face 650 of the modular structure 600 and a second modular structure may be configured along a second face 660 of this modular structure 600. Similarly, other structures may be provided along the other four sides of this multi-sided structure 600.

Alternatively, a wall of the first structure 600 may be removed and then another modular structure (like the multisided structure 600) may be allocated along with wall thereby converting this first structure from a one bedroom living space to perhaps a living space that now comprises twice as much room such as a two bedroom living space.

In one preferred arrangement, the defined virtual environment includes digital assets may comprise a digital currency in the form of a digital fungible token, wherein the fungible token can be duplicated with the same value among each replica. In one preferred arrangement, one or more digital tokens can be transferred between two or more virtual avatars. The amount of digital tokens that can be generated by the virtual real estate may be limited by rules of the virtual environment. In one arrangement, the virtual landlord can transfer to another virtual avatar one or more of the digital tokens that can be generated by the virtual real estate. As described in detail herein, such tokens may be transferred amongst virtual avatars by way of a marketplace.

The method 300 may further comprise the steps of defining a conversion currency that is different from the digital tokens. In one arrangement, this conversion currency may comprise a fiat currency or a crypto currency that defines a relationship between the digital tokens and the conversion. The method 300 may further include the step of defining a marketplace for these digital assets. Such a marketplace would allow two or more real-world users to interchange the digital tokens or can purchase the digital tokens by using the conversion currency.

Returning to the step 310 illustrated in FIG. 3, in one arrangement, users can purchase virtual real estate available at the virtual environment, such as a virtual apartment, and then reside in it or rented out for digital assets, such as digital fungible token or NFTs. In one preferred arrangement, the virtual environment has planning rules with virtual land zoned for certain activities, such as areas for industrial, for residential, for energy generation, for farming, or for residential communities. In one preferred arrangement, these virtual zones may be initiated by the platform and cannot be altered once construction has taken place on these virtual properties.

Certain types of land will not have the unfettered right to do as the user wishes on this land, or built real estate. Rather, purchase of such virtual real estate will require the owner of this land or built real estate to perform some type of execution on the virtual real estate. As just one example, someone may want to purchase a virtual real estate zoned for a restaurant. And the owner fails to establish a restaurant within a given time as spelled out in the NFT associated with this specific virtual real estate. After a certain period of time, if the virtual landowner does not establish this restaurant, the NFT will revert back to the community or the platform owning the virtual environment. Basically, the community is allowing users to become a virtual landowner but at a price. And in one arrangement, this price is that the user needs to use the virtual land, or the virtual built real estate, for the benefit of the community rather than just sit on the land for speculation purposes or financial gains only. Expiring NFTs of virtual real estate provides the security that the virtual environment will be active with activities happening for the good of the active members of the community. In another example, a user may buy the land to build an airport, or the space shuttle needed for the community to travel inside the virtual environment and pay power units to the owner for their use. However, as this infrastructure is critical for the proper functioning of the virtual environment, if the user does not build the airport, under the terms pre-stablished by the virtual environment, the user losses the NFT associated with such virtual land, or the right of use of such NFT.

In an alternative arrangement, a real estate developer in the physical world may sell NFTs of future apartments, through real estate tokenization, and place a digital twin of such apartments in the virtual environment. In such a case, through the use of virtual reality and other immersive tools, users may experience live in such community and even meet their future neighbors. In such case the user/buyer may own the NFT which is an option to buy the actual apartment once the apartment is actually built. Such option may have all the characteristics of stock options, such as premium, intrinsic value, extrinsic value, expiration date and volatility based on the market and developer performance while building the actual structure. As the user will meet in the virtual environment his or her future neighbors, and experience in an immersive manner a replica of their future home, the user can decide to execute the option to buy the physical real estate or let the option expire. In this example, the NFT may also expire if the user does not take certain steps. However, in this case, the steps are related to actions in the physical world, not only in the virtual environment.

The method 300 proceeds to the next step 320 of defining assets for use within the virtual environment. As noted, these assets may comprise two types of digital assets: Fungible tokens and Non-Fungible-Tokens (NFTs). The Fungible Tokens may be of two types, Token Type A, which is limited in numbers and also acts as the platform financing token, and the internal transactional economic tools, or power units (Token Type B) which can be created and burnt by the users while interacting in the virtual environment. In one example, the Non-Fungible-Tokens (NFTs) can also be of two types Solid and Temporary. The Solid NFTs are those where the user is the owner of the digital asset and the owner can enjoy, rent or sell such asset as desired. With a Solid NFT, the virtual environment cannot take back the ownership of such NFT. On the contrary, a Temporary NFT has certain limitations to its use, and: i) it may disappear over time, ii) it may become a Solid NFT is the user performs certain predetermined rules or activities, or iii) it may be a Conditional NFT that is always be linked to a certain activity to be performed by the owner of the NFT. As an example, a virtual land associated with an airport to be built under certain time and terms may always be a Temporary Conditional NFT as the airport not only need to be built but operational for the good of the community. However, an NFT that represents an option to buy physical real estate of an apartment that has been tokenized before its construction in the physical world may be a temporal NFT that always disappears over time but that is linked in its smart contract the right to buy for a predetermined price a solid NFT of the actual apartment. Other samples of NFTs may be loots, chests or consumables that can be used inside the virtual environment during a certain period. Finally, the NFT of the actual apartment may be a solid NFT. Another sample of a Solid NFT inside the virtual environment would be collectables, such as digital art that may be created. An additional example of a conditional NFT is the right to use the virtual environment or to have an avatar inside the virtual environment. In many situations, users need to comply with the terms and conditions of a platform that provides virtual environments to be able to use it. By having a conditional NFT associated with each user, if someone does not comply with the terms and conditions, the platform can execute on the conditional NFT and the user will not be able to use the virtual environment but will not loose any solid NFTs or collectable that might be very valuable in the market. By doing so, the virtual environment separates its use with the ownership of digital assets that might be associated with it.

The method 300 then proceeds to the next step 330 of associating the at least one unit of virtual real estate with an ability to generate an amount of the defined assets for use within the virtual environment. As just one example, the virtual real estate may comprise at least one unit of virtual real estate that is a parcel of virtual land or a built unit of real estate, such as farming facility or a critical infrastructure of the simulated physical environment. In an example of an arrangement where the virtual real estate is virtual land, the usage requirement associated with the conditional NFT is to generate the defined asset that consists of at least one virtual building erected on the parcel of virtual land before a certain period of time from the date of the purchase of the conditional NFT.

Returning to the method 300 illustrated in FIG. 3, the method 300 further comprises the step 340 of linking a conditional Non-Fungible-Token (NFT) to the at least one unit of virtual real estate By conditional it is meant that ownership of the NFT will be conditioned upon the owner of the NFT performing certain things or activities on or with the virtual real estate within the virtual environment. As just one example, the owner may be required to perform certain activities or things within the virtual environment within a particular time frame.

For example, if an owner were to purchase virtual real estate that is designated as an energy producing virtual real estate such as a nuclear power plant. Purchase of such a virtual land will then come with an obligation that the owner must then construct a power generation plant on this land and then use this land for power generation purposes. If the owner were not to utilize the land for such a designated power producing purpose, the owner would in a sense be failing to operate in the best interest of the community by failing to produce the much-needed energy required to make the community grow and become stronger.

In addition, each new power generation source will have limited power generation capacity. As just one example, each new nuclear power generation source would have a maximum power output to support only a number of limited virtual users. For example, a new power generation source may be configured to only provide power support for 2,000 avatars. In other words, the maximum power output might be limited to provide enough power units to provide for the periodic asset needs of 2,000 users of the virtual environment.

Other virtual real estate may be provided with similar use restrictions and conditionals rights. Such other virtual real estate may be used to construct a solar power plant, a nuclear power plant, or a logistics support structure for enabling virtual travel to and from the virtual environment Another type of virtual real estate may comprise a farming location.

Therefore, the owner would then lose the right to own the land and therefore the smart contact coded into the NFT accompanying the land ownership will therefore revert back to the community.

Next, the process 300 proceeds to step 350 where the process includes the step of coding the conditional NFT to provide a conditional right to use the virtual real estate. In one arrangement, this condition nature of the NFT will be coded into a smart contract. The conditions or terms might be directly coded in the smart contract of the NFT, or they might be in a form of a license to use the NFT of a second Solid NFT that is owned by the virtual environment.

Thereafter, the process 300 proceeds to step 360 where the process includes the further step of defining a usage requirement on the virtual real estate associated with the generation of a minimum amount of the defined assets.

Then, the process 300 proceeds to step 370 where the process includes the further step of purchasing the at least one unit of virtual real estate by a virtual landlord thereby obtaining the right of use of the conditional NFT.

In this illustrated exemplary process 300, the process includes the further step 380 of withdrawing the conditional NFT from the virtual landlord if the virtual landlord does not meet the usage requirement on the virtual real estate. As just one example, the purchased virtual real estate may comprise a power generation plant. With such a purchase, the virtual landlord would receive a conditional NFT and the condition would be that the virtual landlord must utilize this virtual real estate for the purpose underlying the conditional NFT. That is, the virtual landlord would be required to work this virtual real estate to meet this usage requirement. And if the virtual landlord does not meet this usage requirement within a given time period as specified by the smart contract underlying the conditional NFT, the conditional NFT would be withdrawn from the virtual landlord.

The process 300 may also include the step of generating one or more virtual avatars representing one or more real-world users. In one preferred arrangement, each virtual avatar belongs to one of a plurality of user profiles inside the virtual environment. As described in detail herein, as an example, these user profiles may comprise Citizens, Explorers, and Travelers.

In in preferred arrangement, the method 400 would further comprise the steps of defining a periodic requirement enabling each virtual avatar to exist within the virtual environment. Then, the method 400 would also include the step of defining a periodic asset allocation of the defined assets that is equivalent to the periodic requirement by each virtual avatar and requiring that each virtual avatar within the virtual environment makes the periodic asset allocation to exist inside the virtual environment. The periodic asset allocation may comprise a periodic allocation of digital tokens. In one arrangement, the one unit of virtual real estate may generate at least the periodic allocation of digital tokens required for one virtual avatar to exist inside the virtual environment.

In one preferred arrangement, the periodic allocation of digital tokens is a digital simulation of the minimum energy that a real-world human would require to generate, either directly or indirectly, in order to survive in a real-world scenario. For example, the periodic allocation of digital tokens would represent a digital simulation of the minimum energy that a real-world human would require to generate in order to survive in a Mars environment. For example, in one arrangement, the at least one unit of virtual real estate comprises a virtual power generation facility. For example, the virtual power generation facility may comprise an ability to generate an amount of power units in the form of the digital tokens for use within the virtual environment Other types of power generation facilities may also be utilized such as solar generation facilities or nuclear generation facilities.

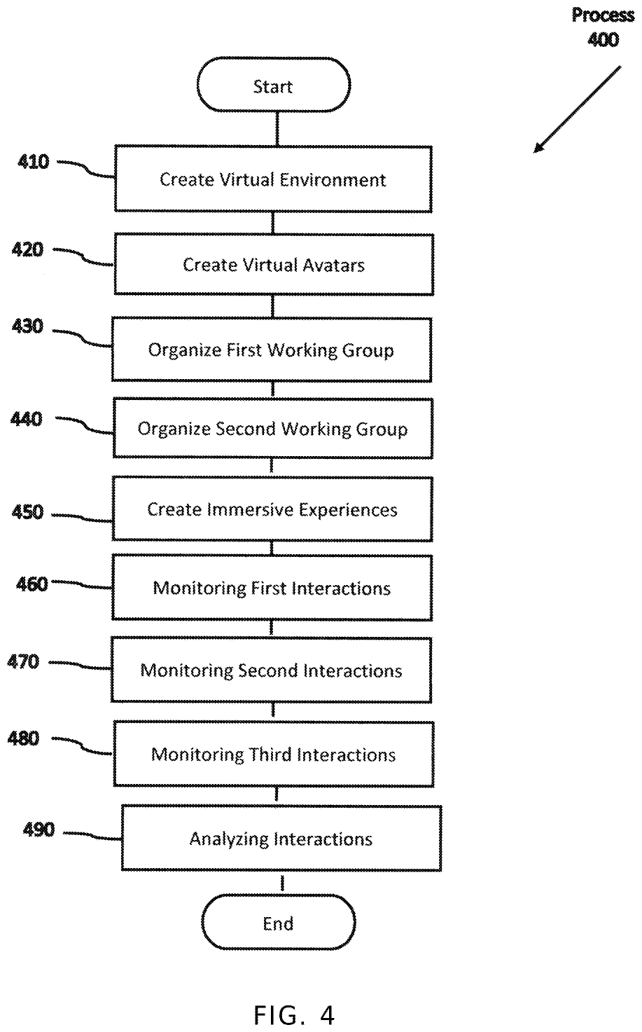

FIG. 4 illustrates a method 400 of analyzing interactions within a virtual environment. In one preferred arrangement, the virtual environment is generated by a computer program that is executed in a computer network system, such as the computer network system illustrated in FIG. 1. Referring to FIG. 4, the method comprises an initial step 410 of creating a virtual environment as a virtual representation of a real-life system. In one preferred arrangement, the real-life system comprises an extreme environment.

Next, process 400 proceeds to step 420 where a plurality of virtual avatars are generated wherein these virtual avatars represent one or more real-world users. The process 400 then proceeds to step 430 wherein the step of organizing a first avatar working group comprising a first plurality of virtual avatars is completed.

The process 400 then proceeds to step 440 where the step includes organizing a second avatar working group comprising a second plurality of virtual avatars;

The process 400 then proceeds to step 450 which comprises the step of creating immersive experiences amongst the plurality of virtual avatars. Such immersive experiences can be competitive experiences where the first group competes against the second group to achieve certain goals or missions, as herein described in detail.

The process 400 then proceeds to step 460 which comprises the step of monitoring a first set of interactions between the first plurality of virtual avatars.

The process 400 then proceeds to step 470 which comprises the step of monitoring a second set of interactions between the second plurality of virtual avatars.

The process 400 then proceeds to step 480 which comprises the step of monitoring a third set of interactions between the first avatar working group and the second avatar working group. The process 400 then proceeds to step 490 which comprises the step of analyzing the first, the second and the third set interactions between the plurality of virtual avatars as they interact with one another within the virtual environment. In one preferred arrangement, the virtual environment comprises a digital twin of the real-life system. In such an arrangement, the result of analyzing the first set of interactions, the second set of interactions, and the third set interactions may produce data on social sciences, or even urban planning and real estate developments, that provide insights on how to change or improve the real-life system. In addition, in such an arrangement, the result of analyzing the first set of interactions, the second set of interactions, and the third set interactions may produce data on behavioral sciences that provide insights on how to change or improve the real-life system.

The process 400 may also include the step of creating one or more conflict opportunities between the plurality of virtual avatars.

The process 400 may also include the step of defining one or more certifications wherein the real-world users learn skills through gamification by interacting with the one or more virtual avatars in the virtual environment. In such an arrangement, the one or more certifications may be associated with knowledge demonstrated by the real-world user while interacting with the one or more virtual avatars.

The process 400 may also include the step of defining assets inside the virtual environment that comprise a digital currency in the form of a digital fungible token. In one arrangement, the fungible token can be duplicated with the same value among each replica, creating two or more digital tokens.

The process 400 may also include the step of establishing at least one earning method for each virtual avatar to earn the digital tokens. In one arrangement, each virtual avatar can earn the digital tokens based in part on the earning method. For example, at least one earning method to earn the digital tokens comprises the step of earning the one or more certifications, wherein one or more digital tokens can be transferred between two or more virtual avatars.

In one arrangement, a non-transitory computer-readable medium having one or more computer programs stored therein is operable by one or more processors to generate a virtual environment is provided. In one arrangement, the virtual environment comprises a virtual reality environment.

Embodiments of the disclosure can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described disclosure can also be stored on the machine-readable medium. Software running from the machine-readable medium can interface with circuitry to perform the described tasks.

The one or more computer programs comprising a set of instructions that are executed by the one or more processors. For example, in one arrangement, the computer-readable medium comprises a cloud based medium. This execution causes the one or more processors to perform a number of the operations.

For example, these operations include generating one or more virtual avatars representing one or more real-world users.

These operations also include generating a virtual environment. In one preferred arrangement, each virtual avatar belongs to one of a plurality of user profiles as described herein.

These operations also include defining a periodic requirement enabling each virtual avatar to exist within the virtual environment.

These operations also include defining assets inside the virtual environment. In one arrangement, the defined assets comprise digital assets that are backed by blockchain technology.

These operations also include establishing at least one earning method for each virtual avatar to earn the defined assets.

These operations also include allowing each virtual avatar to earn the defined assets within the virtual environment based in part on the at least one earning method.

These operations also include defining a periodic asset allocation of the defined assets that is equivalent to the periodic requirement by each virtual avatar.

These operations also include requiring that virtual avatars within the virtual environment make the periodic asset allocation to exist inside the virtual environment.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method of creating a virtual environment, the virtual environment generated by a computer program that is executed in a computer network system, the method comprising the steps of:
generating one or more virtual avatars representing one or more real-world users;
generating a virtual environment wherein each virtual avatar belongs to one of a plurality of user profiles,
defining a periodic requirement enabling each virtual avatar to exist within the virtual environment;
defining assets inside the virtual environment;
establishing at least one earning method for each virtual avatar to earn the defined assets;
allowing each virtual avatar to earn the defined assets within the virtual environment based in part on the at least one earning method;
defining a periodic asset allocation of the defined assets that is equivalent to the periodic requirement by each virtual avatar; and
requiring that each virtual avatar within the virtual environment makes the periodic asset allocation to exist inside the virtual environment.

2. The invention of claim 1, wherein the defined assets comprise digital assets.

3. The invention of claim 1, wherein the periodic requirement comprises an energy requirement.

4. The invention of claim 1,
wherein the virtual environment comprises a digital simulation of a real-world extreme environment wherein human survival is difficult; and
wherein the periodic requirement is a digital simulation of the minimum energy that a real-world user will require to generate, either directly or indirectly, in order to survive in the extreme environment.

5. The invention of claim 4,
wherein the extreme environment comprises a Mars environment.

6. The invention of claim 1 further comprising the step of
defining a marketplace inside the virtual environment wherein two or more real-world users can interchange the defined assets;
defining a relationship between the defined assets inside the virtual environment and a currency, wherein the currency comprises a fiat currency or a crypto currency; and
allowing real-world users to purchase or exchange the defined assets by using the currency.

7. The invention of claim 6 further comprising the steps of
expiring a virtual avatar within the virtual environment if the virtual avatar does not make the periodic asset allocation that is equivalent to the periodic requirement; and
allowing each virtual avatar that has virtually expired within the virtual environment to revive themselves if they make an asset allocation or by obtaining the required assets at the marketplace.

8. The invention of claim 1, further comprising the step of
defining one or more certifications wherein the real-world users learn skills through gamification by interacting with the one or more virtual avatars in the virtual environment;
wherein the one or more certifications are associated with the knowledge demonstrated by the real-world user while interacting with the one or more virtual avatars, and
wherein the at least one earning method to earn the defined assets consists of earning the one or more certifications.

9. The invention of claim 8, further comprising the step of
defining virtual user profiles within the plurality of user profiles, the virtual user profiles relating to a virtual avatar that possess a specific certification among the one or more certifications.

10. The invention of claim 1 further comprising the step of
assembling a first virtual avatar working group within the virtual environment,
wherein this first virtual avatar working group collectively works together to earn assets within the virtual environment,
assembling a second virtual avatar working group within the virtual environment,
wherein this second virtual avatar working group collectively works together to earn assets within the virtual environment; and
wherein this second virtual avatar working group competes against the first virtual avatar working group to earn assets within the virtual environment.

11. The invention of claim 10, further comprising the step of
establishing at least one asset earning method for each virtual avatar working group;
establishing a distribution method wherein the assets earned by the virtual avatar working group gets distributed among the individual avatars that comprise the virtual avatar working group; and
wherein the virtual avatar working groups earn assets by successfully completing a competitive activity.

12. The invention of claim 10 further comprising the step of
defining a first virtual user profile within the plurality of user profiles, the first virtual user profile relating to a virtual avatar who possess a virtual environment identification, thereby allowing this virtual avatar to assemble a virtual avatar working group.

13. The invention of claim 10 further comprising the step of
defining a second virtual user profile within the plurality of user profiles, the second virtual user profile relates to a virtual avatar who does not possess a virtual environment identification and therefore is not allowed to assemble a virtual avatar working group.

14. The invention of claim 10,
wherein each of the virtual avatar working group comprises a maximum of ten individual virtual avatars.

15. The invention of claim 10 further comprising the step of
defining a third virtual user profile within the plurality of user profiles, the third virtual user profile relating to a virtual avatar who owns at least one virtual property within the virtual environment.

16. The invention of claim 1,
wherein the user profiles of the virtual avatars are determined by a type of Non-Fungible-Token that the real-world users own either inside the virtual environment through the virtual avatar or in any other third-party virtual environment.

17. A method of providing assets within a virtual environment, the virtual environment generated by a computer program that is executed in a computer network system, the method comprising the steps of:
generating a virtual environment wherein the virtual environment comprises at least one unit of virtual real estate;
defining assets for use within the virtual environment;
associating the at least one unit of virtual real estate with an ability to generate an amount of the defined assets for use within the virtual environment,
linking a conditional Non-Fungible-Token (NFT) to the at least one unit of virtual real estate;
coding the conditional NFT to provide a conditional right to use the virtual real estate,
defining a usage requirement on the virtual real estate associated with the generation of a minimum amount of the defined assets;
purchasing the at least one unit of virtual real estate by a virtual landlord thereby obtaining the right of use of the conditional NFT; and
withdrawing the conditional NFT from the virtual landlord if the virtual landlord does not meet the usage requirement on the virtual real estate.

18. The invention of claim 17, wherein
the at least one unit of virtual real estate is a parcel of virtual land.

19. The invention of claim 18, wherein
the usage requirement associated with the conditional NFT is to generate the defined asset that consists of at least one virtual building erected on the parcel of virtual land before a certain period of time from the date of the purchase of the conditional NFT.

20. The invention of claim 17, further comprising the steps of
generating one or more virtual avatars representing one or more real-world users;
wherein each virtual avatar belongs to one of a plurality of user profiles inside the virtual environment;
wherein the defined assets comprise a digital currency in the form of a digital fungible token;
wherein the fungible token can be duplicated with the same value among each replica, creating two or more digital tokens,
wherein one or more digital tokens can be transferred between two or more virtual avatars;
wherein the amount of digital tokens that can be generated by the virtual real estate is limited by rules of the virtual environment;
wherein the virtual landlord is a virtual avatar, and
wherein the virtual landlord can transfer to another virtual avatar one or more of the digital tokens that can be generated by the virtual real estate.

21. The invention of claim 20, further comprising the step of
defining a conversion currency that is different from the digital tokens and that comprises a fiat currency or a crypto currency;
defining a relationship between the digital tokens and the conversion currency, defining a marketplace wherein two or more real-world users can interchange the digital tokens or can purchase the digital tokens by using the conversion currency.

22. The invention of claim 21, further comprising the steps of
defining a periodic requirement enabling each virtual avatar to exist within the virtual environment;
defining a periodic asset allocation of the defined assets that is equivalent to the periodic requirement by each virtual avatar,
requiring that each virtual avatar within the virtual environment makes the periodic asset allocation to exist inside the virtual environment;
wherein the periodic asset allocation is a periodic allocation of digital tokens, and
wherein the one unit of virtual real estate generates at least the periodic allocation of digital tokens required for one virtual avatar to exist inside the virtual environment.

23. The invention of claim 22,
wherein said periodic allocation of digital tokens is a digital simulation of the minimum energy that a real-world human will require to generate, either directly or indirectly, in order to survive in a real-world scenario; and
wherein the at least one unit of virtual real estate comprises a virtual power generation facility; and
wherein the virtual power generation facility comprises an ability to generate an amount of power units in the form of the digital tokens for use within the virtual environment.

24. A method of analyzing interactions within a virtual environment, the virtual environment generated by a computer program that is executed in a computer network system, the method comprising the steps of:
creating a virtual environment as a virtual representation of a real-life system;
generating a plurality of virtual avatars representing one or more real-world users;
organizing a first avatar working group comprising a first plurality of virtual avatars;
organizing a second avatar working group comprising a second plurality of virtual avatars;
creating immersive experiences amongst the plurality of virtual avatars;
monitoring a first set of interactions between the first plurality of virtual avatars;
monitoring a second set of interactions between the second plurality of virtual avatars,
monitoring a third set of interactions between the first avatar working group and the second avatar working group; and
analyzing the first, the second and the third set interactions between the plurality of virtual avatars as they interact with one another within the virtual environment.

25. The invention of claim 24, further comprising the step of
creating one or more conflict opportunities between the plurality of virtual avatars.

26. The invention of claim 24,
wherein the real-life system comprises an extreme environment.

27. The invention of claim 24,
wherein the virtual environment comprises a digital twin of the real-life system; and
wherein the result of analyzing the first, the second, and the third set interactions produces data on social or behavioral sciences that provide insights on how to change or improve the real-life system.

28. The invention of claim 27, further comprising the step of
defining one or more certifications wherein the real-world users learn skills through gamification by interacting with the one or more virtual avatars in the virtual environment, wherein the one or more certifications are associated with the knowledge demonstrated by the real-world user while interacting with the one or more virtual avatars,
defining assets inside the virtual environment that comprise a digital currency in the form of a digital fungible token wherein the fungible token can be duplicated with the same value among each replica, creating two or more digital tokens;
establishing at least one earning method for each virtual avatar to earn the digital tokens, wherein each virtual avatar can earn the digital tokens based in part on the earning method;
wherein the at least one earning method to earn the digital tokens consists of earning the one or more certifications,
wherein one or more digital tokens can be transferred between two or more virtual avatars;

29. Non-transitory computer-readable medium having one or more computer programs stored therein operable by one or more processors to generate a virtual environment, the one or more computer programs comprising a set of instructions that, when executed by the one or more processors, cause the one or more processors to perform the operations of:
generate one or more virtual avatars representing one or more real-world users;
generate a virtual environment wherein each virtual avatar belongs to one of a plurality of user profiles;
define a periodic requirement enabling each virtual avatar to exist within the virtual environment;
define assets inside the virtual environment;
establish at least one earning method for each virtual avatar to earn the defined assets;
allow each virtual avatar to earn the defined assets within the virtual environment based in part on the at least one earning method;
define a periodic asset allocation of the defined assets that is equivalent to the periodic requirement by each virtual avatar, and
require that each virtual avatar within the virtual environment makes the periodic asset allocation to exist inside the virtual environment.

30. The invention of claim 29,
wherein the computer-readable medium is a cloud based medium;
wherein the virtual environment is a virtual reality environment; and
wherein the define assets are backed by blockchain technology.
